(19) United States
(12) Patent Application Publication
(10) Pub. No.: US 2024/0308619 A1
(43) Pub. Date: Sep. 19, 2024

(54) Fork Chassis Air Bleeder

(71) Applicant: PUSH INDUSTRIES INCORPORATED, Loveland, CO (US)

(72) Inventor: Matt White, Timnath, CO (US)

(73) Assignee: PUSH INDUSTRIES INCORPORATED, Loveland, CO (US)

(21) Appl. No.: 18/603,921

(22) Filed: Mar. 13, 2024

Related U.S. Application Data
(60) Provisional application No. 63/451,838, filed on Mar. 13, 2023.

(51) Int. Cl. B62K 25/08; B62K 25/04

(52) U.S. Cl. CPC B62K 25/08; B62K 2025/048; B62K 2201/08

(57) ABSTRACT

A fork assembly includes a linearly fixed tube and a linearly moving stanchion. An air bleed mechanism is located in an upper portion of the fork assembly, preferably in a chassis crown of the fork assembly. The air bleed mechanism is configured to permit the equalization of pressure between an internal cavity located in the linearly fixed tube and/or the linearly moving stanchion.

### PRIORITY CLAIM

This application claims benefit U.S. Provisional Patent Application No. 63/451,838 filed on Mar. 13, 2023, and which is fully incorporated herein.

### TECHNICAL FIELD

The present application generally relates to suspension systems for vehicles, and more specifically, but not exclusively, to an air bleed assembly located at an upper portion of a bicycle fork

### BACKGROUND

Bicycles commonly include suspension systems. These suspension systems increase rider comfort and can enable a more effective power transfer to the ground, as is known with automotive suspensions. Air-sprung suspension systems are commonly utilized with mountain bikes. A front bicycle suspension system frequently includes a telescopic fork having two legs which straddle the front wheel of the bicycle.

The wheel rotates around an axle which is coupled to a lower portion of the telescopic fork. The telescopic fork includes the bump absorbing internal components, typically include at least one damper and a spring. Prior art forks frequently locate the damper in one leg and include the spring in the other leg.

As the wheel encounters uneven terrain, forces from the axle are transmitted to the sliding stanchions (e.g., the telescoping tubes). These stanchions are operably coupled with the spring and damper. The spring and damper serve to reduce the harshness of these forces and are typically structured to keep the wheel firmly coupled to the ground, enabling an efficient transfer of power. As the wheel travels up and down over bumps in the ground, the sliding stanchions travel inwardly and outwardly in a linear fashion from non-moving tubes of the fork with the spring and damper providing bump absorption and damping.

Current fork designs include internal cavities that are sealed to retain lubricating fluid and to exclude debris from contaminating the suspension system. Known conventional forks, such as Right Side Up or Standard forks, and inverted forks include such sealed internal cavities.

Manufacturers can include an air spring within the spring leg. This can be accomplished via the incorporation of a partition and plunger within the spring leg. In this design, the plunger divides the internal cavity into a spring cavity on a first side of the plunger and a non-spring cavity on a second side of the plunger. An air adjustment port can be utilized to adjust the pressure within the spring cavity, and therefore the spring effect provided by the plunger acting on the air spring cavity. The non-spring cavity is typically viewed as trapped air.

Pressure within the non-spring cavity (also known as the trapped air cavity) influences the overall spring rate. The non-spring cavity can negatively impact the suspension characteristics of the fork depending upon the air pressure confined within the non-spring cavity. Significant changes in temperature or elevation, relative those in the manufacturing facility where the non-spring cavity was sealed, will impact the pressure within the non-spring cavity. The pressure within the trapped air cavity can be positive (i.e., greater than atmospheric pressure) or negative (i.e., less than atmospheric pressure).

Positive pressure trapped within the non-spring cavity will be compressed further when the stanchions are moved into the fixed tubes, as will occur during a ride when a bump is encountered. This increased pressure within the non-spring cavity exerts an increased force on the sliding seals, located between the stanchions and the non-moving tubes. The increased force pressing against the seals usually results in increased friction between the stanchions and the fixed tubes which reduces overall system performance.

To minimize such undesirable system performance and characteristics, riders of prior art systems having fork designs with a tool-free air adjustment port will often adjust the pressure within the spring cavity in an attempt to compensate for the change in pressure within the non-spring cavity. In fork designs that do not have tool free adjustment parts, riders will often not adjust the air, and will just manage with this less than desirable spring rate and/or suspension characteristics.

U.S. Pat. Nos. 9,739,331, 10,746,250, and 11,293,513 teach of the integration of a bleeder valve into the lower, moving portion of a fork assembly. Fox Factory, ROCKSHOX/Sram, and MRP presently offer mountain bike forks having bleeder valves located at the lower portion of the fork. These bleeder valves extend outwardly from the lower tubes and function via a push to bleed system (e.g., a user depresses a button and the valve opens and bleeds air).

Although these prior art bleeder valves function in a workmanlike manner to release pressure from sealed cavities within the fork, there are numerous drawbacks to these designs. For example, these prior art bleeder valves are known to undesirably permit oil to escape from the assembly as air is bled therefrom.

These prior art bleeder valves are also frequently damaged and inadvertently activated due to contacting obstacles, debris, etc. on the trail. Riders have been known to inadvertently block the bleed passageway when they depress the bleed button, because while doing so, their finger extends over the bleed passageway.

Some motorcycles include bleeder valves located in the top sealing caps of the fork. These bleeder valves often require tools to operate. This bleeder location is believed to be suitable for motorcycles due to the large diameter of the telescoping tubes and overall large fork size. However, this bleeder location would not be desirable for a bicycle having adjustment knobs above the sealing caps as the adjustment knobs would probably be too small to be easily operated, since the adjustment knob would have to be scaled down considerably to accommodate a bleed valve in the limited space available above the sealing caps of a typical bicycle.

Therefore, further technological developments are desirable.

### SUMMARY

One form of the present application is directed to a fork assembly including an air bleeder located at the upper, non-moving portion of the fork assembly. The air bleeder is configured to permit trapped air to be bled from a sealed cavity located internally of the fork assembly. The air bleeder can be located in the chassis crown. A first air bleeder can be located in the chassis crown at a first leg of the fork, and a second air bleeder can be located in the chassis crown at a second leg of the fork.

A further form of the present application is directed to an air bleeder assembly. This air bleeder assembly is configured to permit air to bleed from a sealed cavity in the fork assembly when a bleeder control member, such as a knob is pulled outwardly. This air bleeder assembly can include a plunger located in a fluid passageway.

The plunger can slide in the fluid passageway between a first position and a second position. The air bleeder assembly can be placed a closed configuration when a proximal end of the sliding plunger is slid inwardly to the first position in which the proximal end blocks the fluid passageway.

The air bleeder assembly can be placed in an open configuration (e.g., bleed configuration) by sliding the plunger outwardly to a second position in which the plunger fails to fully block the fluid passageway to thereby allow air to travel through the fluid passageway. The air bleeder assembly can include an automatic bleed that is configured to bleed air from the sealed internal cavity absent user intervention.

Further forms of the present application include unique bicycle fork air bleed apparatuses, devices, systems, and methods. Further embodiments, inventions, forms, objects, features, advantages, aspects, and benefits of the present application are otherwise set forth or become apparent from the description and drawings included herein.

### BRIEF DESCRIPTION OF THE DRAWINGS

The description herein makes reference to the accompanying drawings wherein like reference numerals refer to like parts throughout the several views, and wherein:

FIG. 1 depicts a perspective view of an exemplary bicycle fork assembly according to a first form of the present application;

FIG. 2 depicts a rear perspective view of an upper portion of the fork assembly, depicting exemplary bleed valves located at a chassis crown of the fork assembly;

FIG. 3 depicts a cut-away view of an exemplary spring leg of the fork assembly;

FIG. 4A depicts a cross-sectional view of an exemplary air bleeder assembly according to a further form of the present application, the air bleeder assembly being depicted in an open configuration;

FIG. 4B depicts a cross-sectional view of the air bleeder assembly of FIG. 4A in a closed configuration;

FIG. 5 depicts an enlarged view of the chassis crown of FIG. 3, including the cut-away view of the spring leg;

FIG. 6 depicts a rear biased perspective view of the chassis crown of the fork assembly, depicting the damper leg at the chassis crown partially cut-away;

FIG. 7 depicts top view of the fork assembly of FIG. 1;

FIG. 8 is a perspective view of an exemplary crown ring having a threaded aperture;

FIG. 9 depicts a perspective view of an exemplary plunger of the air bleeder assembly of FIGS. 4A-4B;

FIG. 10A depicts a perspective view of an exemplary valve body of the air bleeder assembly;

FIG. 10B depicts a cross-sectional view of the valve body of FIG. 10A, taken along a lengthwise axis of the valve body;

FIG. 11 is a side cross-sectional view of the bicycle fork taken at the bleeders;

FIG. 12 is a bottom cross-sectional view of the bicycle fork taken at the bleeders; and

FIG. 13 is a sectional view of the fork highlighting the damper cart ridge.

The accompanying drawings incorporated in and forming a part of the specification illustrate various forms and features of the present application; however, the present application should not be construed as being limited to those specific embodiments depicted in the drawings.

### DETAILED DESCRIPTION

For purposes of promoting an understanding of the principles of the invention, reference will now be made to the embodiments illustrated in the drawings and specific language will be used to describe the same. It will nevertheless be understood that no limitation of the scope of the invention is thereby intended. Rather, alterations and further modifications in the illustrated device, and any further applications of the principles of the invention as illustrated therein are contemplated as would normally occur to one skilled in the art to which the invention relates.

As used herein, the terms “fixed”, “linearly fixed”, and “non-moving” with regard to various components are intended to encompass components which are substantially fixed relative the linearly moving stanchions. Generally, these fixed components are considered fixed with regard to the shock absorbing system of the fork assembly. However, it should be understood that such “fixed” and “linearly fixed” components can move during steering and can include various movements in response to forces which are exerted upon the fixed component especially those forces that are encountered during rides on rough terrain.

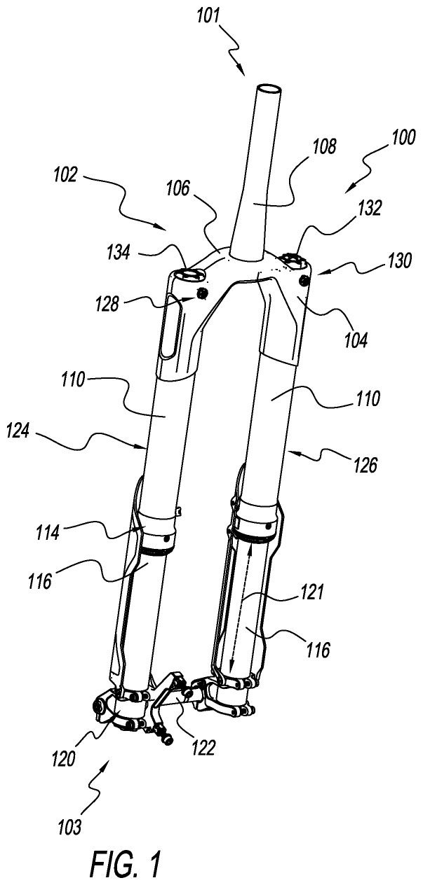

Referring now to FIG. 1, an exemplary bicycle fork assembly 100 includes a forward surface 102, a rearward surface 104, an upper portion 101, and a lower portion 103. The fork assembly 100 includes a chassis crown 106, a steering tube 108, and two legs 124, 126. The first leg 124 extends substantially parallel to the second leg 126.

An axle 122 is configured to rotatably receive a wheel (not shown) thereon. The axle 122 passes through a hub (not shown) of the wheel so that the wheel can rotate around the axle 122. The axle may comprise a removable skewer (not shown). The axle 122 extends between, and is coupled to, the first leg 124 and the second leg 126. Near their 124, 126 distal ends or lower ends the first leg 124 and the second leg 126 each include a fixed component 110 and a moving component 116. When fully assembled on a bicycle, the first leg 124 and the second leg 126 straddle opposing sides of the wheel (not shown).

The bicycle fork assembly 100 is depicted as taking the form of an inverted design. In this inverted design, the moving components 116 are located at the lower portion 103 of the fork assembly 100 while the fixed or stationary components 110 are located at an upper portion 101 of the fork assembly 100.

The fixed components 110 are depicted as taking the form of linearly fixed hollow tubes 110. Referring now to FIGS. 1, 3, and 5, each fixed tube 110 is depicted as extending between a proximal end 112 and a distal end 114. The proximal end 112 of each fixed tube 110 is fixedly coupled with the chassis crown 106. The fixed tubes 110 can be fixedly coupled with the chassis crown 106 via adhesive. However, it is also contemplated that the fixed tubes 110 can be fixedly coupled with the chassis crown 106 through various joining techniques including welding.

Also, mechanical fasteners can be integrally formed with the chassis crown 106, or the like. The steering tube 108 can be fixedly coupled to the chassis crown 106. In this manner, the non-moving upper portion 101 of the fork assembly 100 includes the chassis crown 106, the hollow tubes 110, and can include the steering tube 108.

The linearly moving components 116 are depicted as taking the form of hollow tubes and will be referred to as stanchions 116.

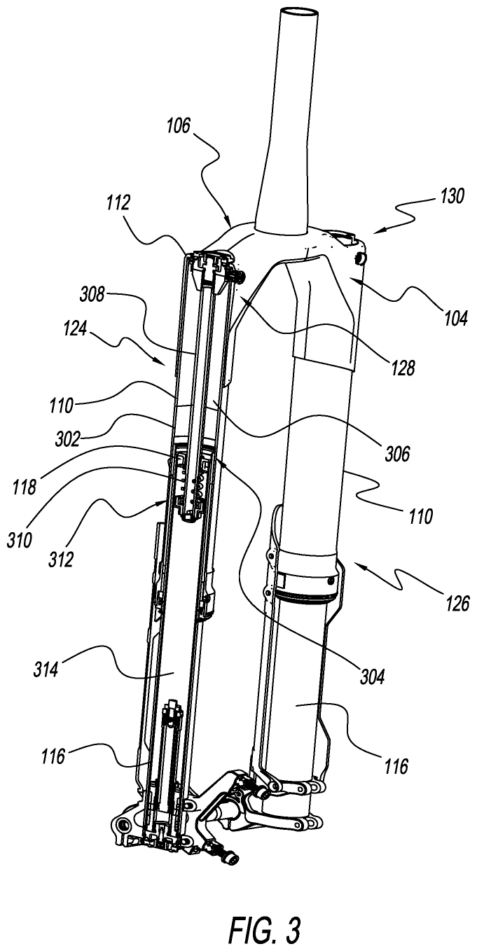

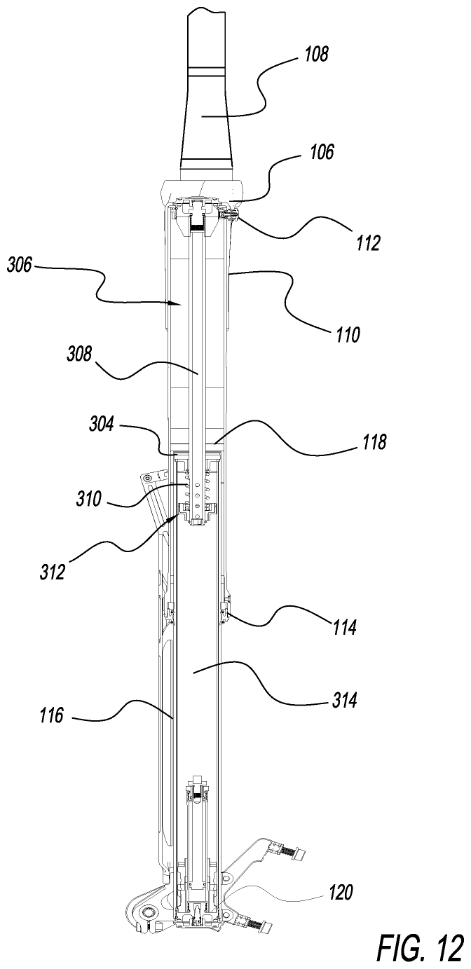

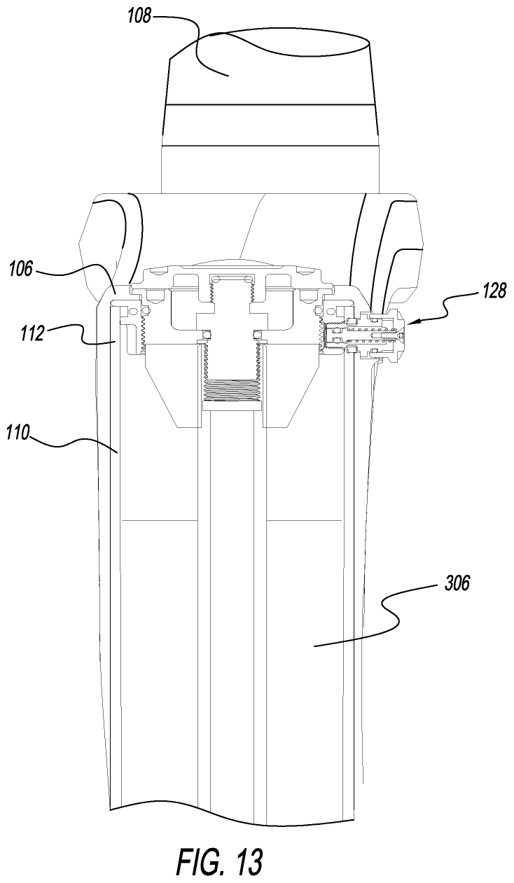

Although the tubes are usually cylindrical, they may take other cross-sectional shapes such as ovaloid or hexagonal. Referring now to FIGS. 1 and 12, the stanchions 116 extend between a proximal end 118 and a distal end 120 (FIG. 3). The axle 122 is affixed to the stanchions 116 at the distal end 120. The proximal end 118 of each stanchion 116 is depicted as being interiorly, slidably received within the interior passageway of the distal end 114 of the fixed tube 110.

As is best shown in FIGS. 3 and 12, an outer diameter of the proximal end 118 of the stanchions 116 can be closely received by an inner diameter of the hollow passageway of the fixed tubes 110. A sliding seal (not shown) can be located where the stanchions 116 and the fixed tubes 110 interact. The stanchions 116 are configured to move in an inwardly and outwardly direction relative the fixed tubes 110 along axis 121, which can be described as a linear reciprocating motion having irregular timing and distance intervals.

The fork assembly 100 has a suspension assembly operably coupled between the linearly moving stanchions 116 and the fixed chassis crown 106. As is illustrated in FIGS. 3, 5, and 6, the suspension assembly can include a spring assembly located in the hollow internal cavity of the first leg 124 and can include a damper assembly located in the hollow internal cavity of the second leg 126.

The first leg 124 will be referred to hereinafter as the spring leg 124 and the second leg 126 will be referred to hereinafter as the damper leg 126.

Referring back to FIG. 1, a damper adjustment knob 132 can be located atop the damper leg 126 and a spring adjustment knob 134 can be located above the spring leg 124, as is known.

As the wheel encounters obstacles, such as bumps and uneven terrain, Y-axis forces, along axis 121 are transferred from the wheel to the axle 122 and to the stanchions 116. As the movable stanchions 116 are pushed upwardly into the fixed tubes 110, the suspension system, which includes the spring assembly in the spring leg 124 and the damper assembly in the damper leg 126 absorbs the harsh impacts or “shocks” which helps to keep the wheel firmly planted to the ground, provides efficient power transfer, and increases user comfort.

Inappropriate amounts of an air pressure within the sealed internal cavities of the fork assembly 100 can be caused by changes in temperature and/or elevation. Such inappropriate air pressures can negatively impact the suspension characteristics, especially spring rate. The air bleeder assemblies 128, 130 are configured to selectively permit fluid flow between the sealed internal cavities and the external atmosphere, thus providing for the pressure internal to the sealed internal cavities to be equalized with atmospheric pressure.

The fork assembly 100 includes an air bleeder assembly 128 which is located in the non-moving upper portion 101 of the fork assembly 100. The air bleeder assembly 128 can be located at the chassis crown 106.

Referring to FIGS. 1 and 3, the air bleeder assembly 128 is depicted as being located on the spring leg 124 and is configured to selectively permit the bleeding of air from a sealed internal cavity of the spring leg 124 to the external atmosphere. The sealed internal cavity can take the form of non-spring trapped air cavity 306.

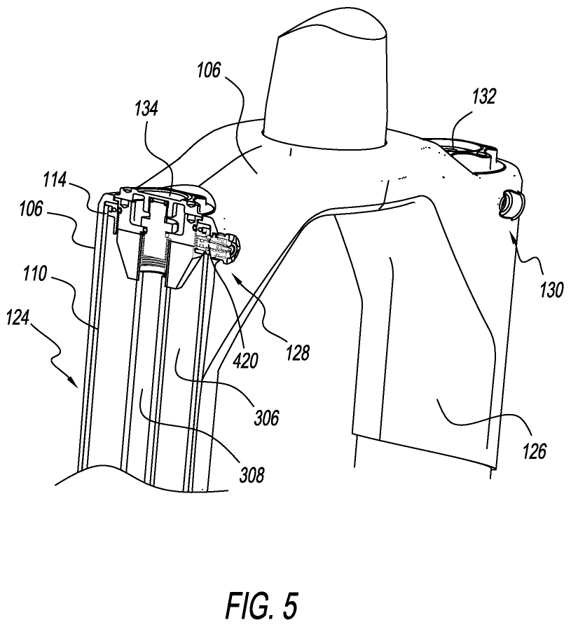

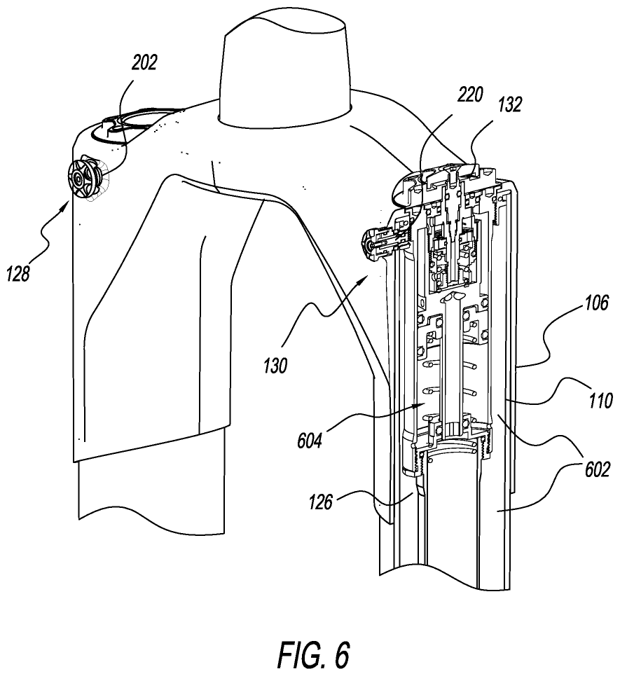

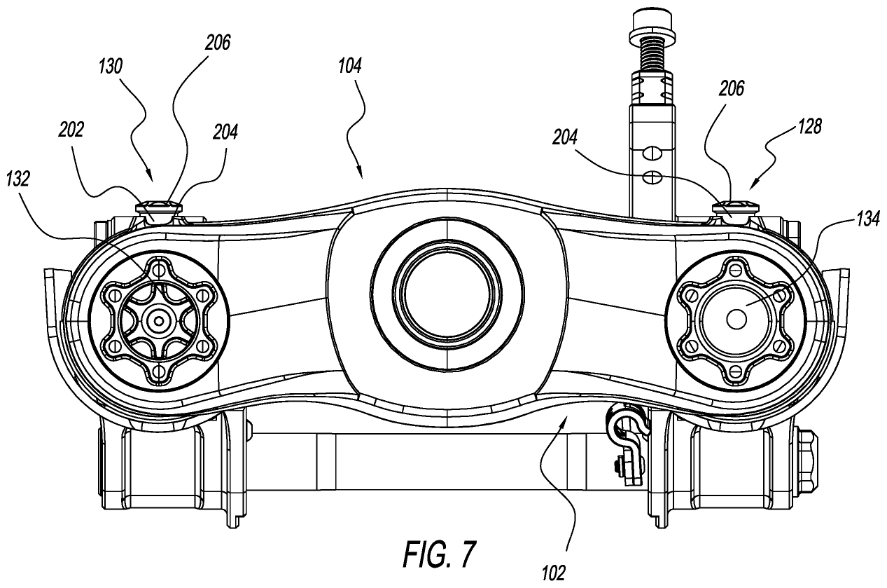

An air bleeder assembly 130 can be located at the chassis crown 106 on the damper leg 126 to selectively permit the bleeding of air from a sealed internal cavity of the damper leg 126 to the external atmosphere. The sealed internal cavity of the damper leg 126 can take the form of trapped air cavity 602 as is best illustrated in FIG. 6.

Applicants have discovered that locating the air bleeder assemblies 128, 130 into the chassis crown 106 prevents the leakage of oil therefrom. Applicants have found that oil disposed internally of the fork assembly 100 will migrate downwardly to the lower portion 103 of the legs 124, 126, while the air bleeder assemblies 128, 130 are located toward the top of the legs 124, 126. Moreover, the location of the bleeder assemblies 128, 130 into the chassis crown 106 provides users ease of access to the bleeder assemblies 128, 130 and reduces the likelihood of damage from contacting obstacles and debris during a ride. This occurs because of the increased height of the bleeder assemblies 128, 130 relative to bleeder assemblies in known prior art devices.

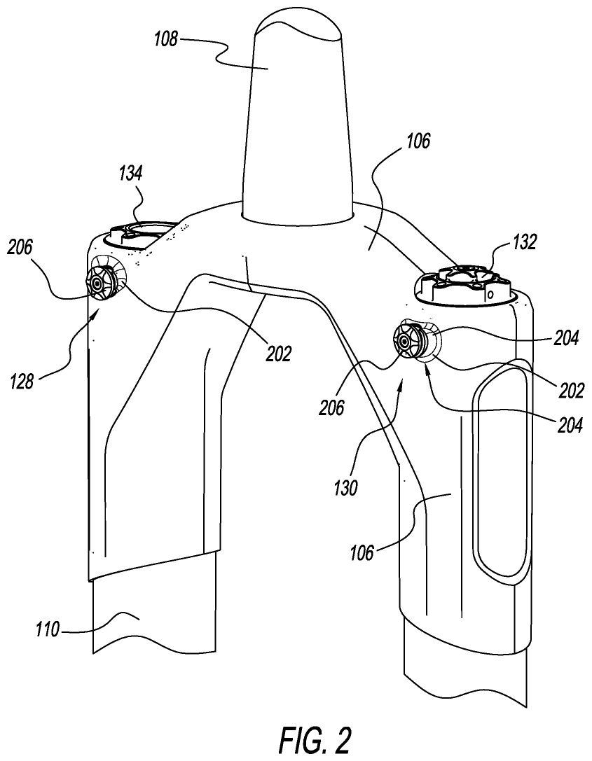

As best shown in FIG. 2, the air bleeder assemblies 128, 130 each include an externally accessible actuator 206. This actuator 206 is depicted as taking the form of pull knob 206. The pull knobs 206 are preferably located adjacent to, and are oriented substantially perpendicular to the damper adjustment knob 132 and the spring adjustment knob 134.

This location of the pull knobs 206 is believed to be highly advantageous as users are familiar with the adjustment knobs 132, 132 and will readily locate the pull knobs 206 nearby. This pull knob 206 location permits the damper adjustment knob 132 and the spring adjustment knob 134 to fill the limited space in the chassis crown above the damper leg 126 and the spring leg 124, respectively.

The air bleeder assemblies 128, 130 can include an outward protection flare 202. The protection flare 202 protrudes outwardly from the chassis crown 106 toward an outward surface of the pull knob 206, and extends substantially around an outer diameter of the pull knob 206.

The protection flare 202 is configured to protect the pull knobs 206 and air bleeder assemblies 128, 130 from impacts and debris which can be encountered during use. The protection flare 202 includes finger grooves 204 on opposing sides of the pull knob 206. The finger groves 204 are configured to permit a user to grip the pull knob 206 easily.

Referring briefly to FIGS. 3 and 12, the spring leg 124 includes an air spring assembly that includes a shaft 308, a partition 304, a spring plunger 312, and a spring 310. An air spring cavity 314 is located below the spring plunger 312, and a trapped air non-spring cavity 306 is created above the spring plunger 312. The air bleeder assembly 128 enables a user to equalize the pressure within the non-spring cavity 306 of the spring leg 124 with the atmosphere.

For example, if the air pressure within the non-spring cavity 306 is greater than atmospheric pressure it can negatively impact suspension characteristics and increase suspension system friction. The air bleeder assembly 128 can enable a user to vent air from the non-spring cavity 306 to the atmosphere, thereby releasing pressure from within the non-spring cavity 306 to counteract the negative impact.

It has been discovered that negative pressure within the non-spring cavity 306, relative atmospheric pressure, can be advantageous. Negative pressure within the non-spring cavity 306 can help offset the initial static friction of the system. Specifically, the vacuum created in the non-spring cavity 306 can help to pull the stanchions into the fixed tubes. Moreover, the inclusion of negative pressure within the non-spring cavity 306 can be utilized to compensate for the pressure increase in the non-spring cavity 306 when the suspension is compressed.

A spring cavity fill port (not shown) can be placed in fluid communication with the air spring cavity 314. A user can adjust pressure within the air spring cavity 314 by utilizing the air spring fill port and a suitable source of pressure such as a bicycle pump, CO₂ tube, air compressor, etc.

This spring cavity fill port can be located near the spring adjustment knob 134. This exemplary spring leg 124 includes a spring cavity fill port in fluid communication with the air spring cavity 314. The air spring cavity 314 is shown as being the spring plunger 312. The air bleeder assembly 128 is placed in fluid communication with the trapped air non-spring cavity 306 which is shown being positioned above the spring plunger 312.

The air bleeder assemblies 128 and 130 can enable a user to intentionally create a negative (sub-atmospheric) pressure environment within the trapped air cavities of the fork assembly 100. This can be accomplished by the user compressing the fork assembly 100, then actuating one or more of the bleeder assemblies 128 and 130.

In this manner when the fork assembly 100 is compressed, air will vent from the non-spring cavity 306 of the spring leg 124 and/or air will vent from the trapped air cavity 602 of the damper leg 126, depending upon if the user activates one or both of the bleeder assemblies 128 and 130. When the user stops compressing the fork assembly 100, the stanchions will move outwardly from the fixed tubes resulting in negative pressure within the trapped air cavity or cavities.

Turning to FIG. 6, the damper leg 126 includes a damper assembly. This damper assembly can comprise a damper cartridge 604, which is located inside the hollow internal cavity of the damper leg 126. This damper cartridge 604 is shown as a sealed oil containing unit. An exemplary cartridge assembly is depicted in U.S. Provisional Patent Application No. 63/417,527, filed Oct. 19, 2022, and titled TORSION RESISTANT BICYCLE FORK, the disclosure of which is fully incorporated herein.

As is illustrated, a trapped air cavity 602 is defined between the damper cartridge 604 and the fixed tube 110. The air bleeder assembly 130 enables a user to equalize the pressure within the trapped air cavity 602 with the external atmosphere. This equalization occurs by venting from the trapped air cavity 602 of the damper leg 126 venting to the atmosphere, or by air entering into the trapped air cavity 602 from the atmosphere, depending upon the pressure of the trapped air cavity 602 relative to atmospheric pressure.

The internal components of the air bleeder assembly 130 are substantially similar to the air bleeder assembly 128. The primary distinction between the air bleeder assembly 128 and air bleeder assembly 130 is with regard to the mounting location. Specifically, the air bleeder assembly 128 is located at the spring leg 124 and is configured to allow for the pressure equalization of the trapped air in the spring leg 124 with the atmosphere. In contrast, the air bleeder assembly 130 is located at the damper leg 126 and is configured to allow for the pressure equalization of the trapped air within the damper leg 126 with the atmosphere.

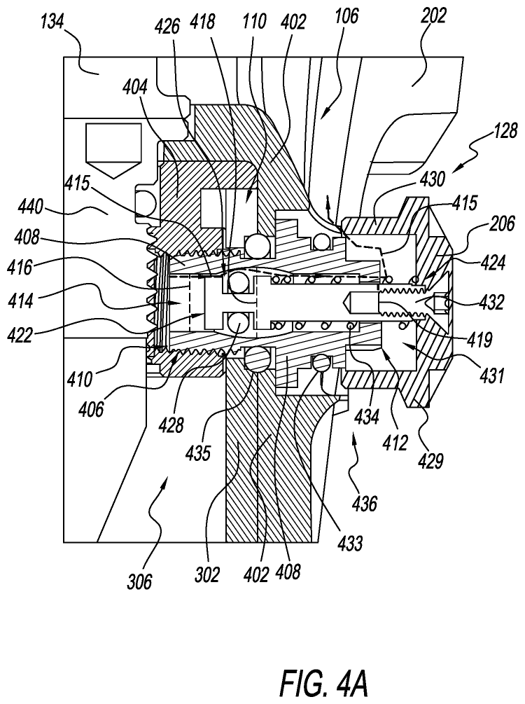

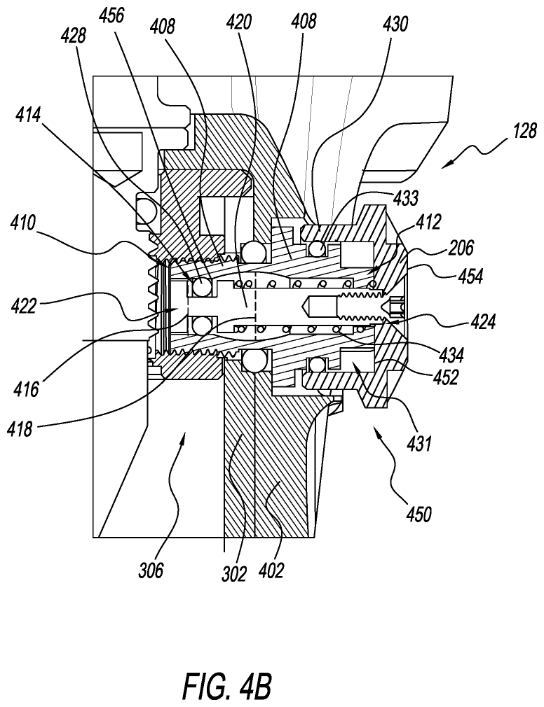

Referring now to FIG. 4A, an exemplary air bleeder assembly 128 will now be described. The air bleeder assembly 128 is configured to selectively place the trapped air non-spring cavity 306 in fluid communication with the external atmosphere. When the air bleeder assembly 128 is placed in an open configuration 436 (as is depicted in FIG. 4A), fluid flow is permitted between the non-spring cavity 306 and the external atmosphere. Therefore, the pressure within the non-spring cavity 306 will equalize with atmospheric pressure.

If the pressure within the non-spring cavity 306 is greater than atmospheric pressure, air will flow from the non-spring cavity 306 to the atmosphere. If the pressure within the non-spring cavity 306 is less than atmospheric pressure, air will flow from the atmosphere into the non-spring cavity 306.

The air bleeder assembly 128 includes a valve body 408, a fluid passageway 414, and a plunger 420. The valve body 408 is shown extending through the outer wall 302 of the linearly fixed tube 110 in the upper fork. The valve body 408 can be located at the chassis crown 106 of the fork assembly 100.

The valve body 408 extends between a first end 410 and a second end 412. The second end 412 of the valve body 408 is depicted as extending outwardly from the outer housing 402 of the chassis crown 106. The valve body 408 is depicted as extending through the outer housing 402 of the chassis crown 106 and the outer wall 302 of the linearly fixed tube 110.

The valve body 408 is removably coupled with the fork assembly 100. The first or inner end 410 of the valve body 408 is depicted as threadedly engaging with a female threaded aperture 406 which extends through a sidewall of the crown ring 404. Referring to FIGS. 4A, 8, and 10A-10B, the valve body 408 is depicted as including male threads 1004 that are disposed adjacent to the first end 410. These threads 1004 are configured to threadedly engage threads of the female threads of the threaded aperture 406 of the crown ring 404 to firmly secure the valve body 408 into the fork assembly 100.

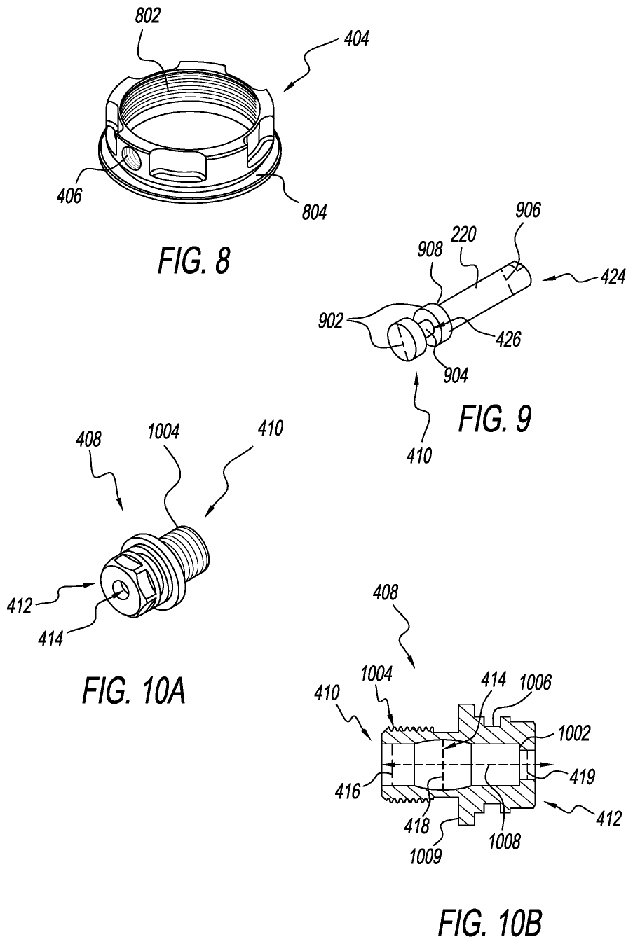

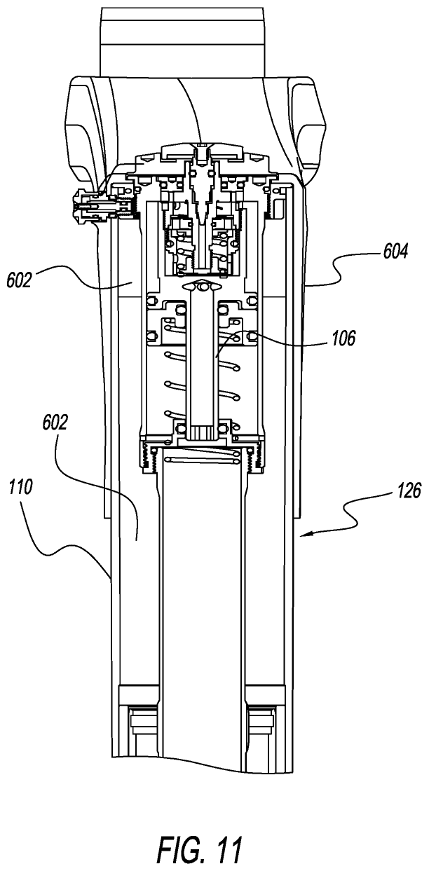

Referring now to FIGS. 4A and 8, the crown ring 404 is fixedly connected with the proximal end 112 of the linearly fixed tube 110. The crown ring 404 is preferably inserted into the hollow interior of the linearly fixed tube 110 at the proximal end 112 with the lower radically outwardly extending flange surface 804 of the crown ring 404 abutting the proximal end 112.

The crown ring 404 can be fixedly attached with the linearly fixed tube 110 via various adhesives, joining techniques such as welding, brazing, etc., and/or mechanical fasteners. The crown ring 404 includes internal female threads 802 which are configured to engage with the male threads of the top sealing cap 440.

Referring now to FIGS. 4A, and 10A-10B, the air bleeder assembly 128 can include a number of sealing members including a tube seal 435, a dust seal 433, and a main bleed seal 428. In one embodiment, the seals 435, 433, and 428 comprise O-rings that are formed of Buna-N. However, it is contemplated that a variety of other sealing member and materials can be utilized.

The tube seal 435 is positioned to encircle an exterior surface of the valve body 408. When the valve body 408 is threaded into the aperture 406 in the crown ring 404, the tube seal 435 is sealingly pressed between the exterior of the valve body 408 and the outer wall 302 of the fixed tube 110, and can also contact the outer housing 402 of the chassis crown 106.

The valve body 408 can include an outward protrusion 1009 which can contact the tube seal 435, forcing the tube seal 435 against a seal receiving groove 437 in the outer wall 302. The dust seal 433 will be discussed hereinafter with regard to FIG. 4B, and the main bleed seal 428 will be described hereinafter with regard to the plunger 420.

Referring now to FIGS. 4A and 10A-10B, a fluid passageway 414 extends from the non-spring trapped air cavity 306 to the atmosphere, external to the fork assembly 100. The valve body 408 is depicted as having a substantially hollow interior, which at least partially defines the fluid passageway 414. The fluid passageway 414 is depicted as extending from the first end 410 of the valve body 408 to the second end 412.

The fluid passageway 414 can include a first diameter 416 located relatively closer to the first end 410, an exit diameter 419 located relatively closer to the second end 412, and an expanded diameter 418 located between the first diameter 416 and the exit diameter 419. As is illustrated, the expanded diameter 418 has a greater diameter and cross-sectional area than the first diameter 416. The exit diameter 419 is depicted as having a smaller diameter and cross-sectional area than the first diameter 416.

Referring to FIGS. 4A, 9, and 10B, a plunger 420 is slidably received within the passageway 414. The plunger 420 functions as a valve and provides for the selective opening and closing of the passageway 414. The plunger 420 has a substantially cylindrical form comprised of multiple cylindrical segments having different outer diameters. However, the plunger 420 can take a variety of forms and have a variety of shapes to selectively obstruct the passageway 414 to prevent the passage of air therethrough.

The plunger 420 is sized and configured to extend between a proximal end 422 and a distal end 424. When the plunger 420 is in an assembled state by being inserted into the passageway 414 of the valve body 408, the proximal end 422 of the plunger 420 is positioned near the first end 410 of the valve body 408 and the distal end 424 of the plunger 420 is positioned near the second end 412 of the valve body 408.

A main bleed seal 428 can exteriorly encircle the plunger 420 near the proximal end 422 of the plunger 420. A reduced diameter main bleed seal receiving groove 426 is formed the proximal end 422 of the plunger 420 and away from the distal end 424. The seal receiving groove 426 is depicted as being located between expanded diameter portions 902.

The distal end 424 of the plunger 420 includes a diameter 906. The expanded diameter portions 902 are depicted as being larger in size and cross-sectional areas than the diameter 906, and the diameter 906 is depicted as being larger in size and cross-sectional area than the diameter 904 of the seal receiving groove 426.

The pull knob 206 is attached to the distal end 424 of the plunger 420, and is affixed to the plunger 420 via a screw 432. In this manner, movement of the pull knob 206 will cause movement of the plunger 420. However, it is contemplated that the pull knob 206 can be affixed to the plunger 420 through a variety of fasteners, adhesives, fittings or the like. For example, the distal end 424 of the plunger 420 can be threaded with the pull knob 206 screwing thereon or interference-type fit can be utilized.

Referring to FIGS. 4A and 4B, the pull knob 206 can include a cap-type appearance. The pull knob 206 has an outer surface 454, an interior surface 452, a dust cover 430 extending from the interior surface 452 away from the outer surface 454, and an interior cavity 431. The interior cavity 431 is defined between the interior surface 452 and the interior walls of the dust cover 430. A grasping rim 429 is located around a perimeter of the pull knob 206, toward the outer surface 454.

The plunger 420 is slidably received within the fluid passageway 414. The plunger 420 slides along axis 1008 between a first position in which the plunger 420 blocks the fluid passageway 414 and a second position in which the plunger fails to fully block the fluid passageway 414.

When the plunger 420 is located in the first or closed position, the air bleeder assembly 128 is in a closed configuration 450, depicted in FIG. 4B. In this first position, the proximal end 422 of the plunger 420 is located at the first end 410 of the valve body 408. In this first position, plunger 420 completely blocks the fluid passageway 414.

As is illustrated, in this first position the main bleed seal 428 is firmly pressed between and sealingly engages the plunger 420 at plunger diameter 904, and an interior surface 456 of the valve body 408. In this manner, the plunger 420 and the main bleed seal 428 completely fill and block the first diameter of the passageway 414, thereby preventing the flow of air through the passageway 414.

When the plunger 420 is placed in the second or open position, the air bleeder assembly 128 is placed in an open configuration 436, illustrated in FIG. 4A. In this second position, the proximal end 422 of the plunger 420 is slid away from the first end 410 of the valve body 408 toward the second end 412 to create a gap between the plunger 420 and the first end 410 of the valve body 408.

In this second position, the proximal end 422 of the plunger 420 is positioned in the enlarged diameter 418 of the passageway 414 and the main bleed seal 428 is placed in a spaced relation to the interior surface of the valve body. When so positioned, the bleed seal fails to contact and sealingly engage with the interior surface 456 of the valve body 408, since the diameter of the enlarged diameter portion 418 of the passageway 414 is greater than the outer diameter of the main bleed seal 428.

When the plunger 420 is placed in this second position, the passageway 414 is not fully blocked. Rather, a flow path 415 exists that is defined between the main bleed seal 428 and the interior surface 456 of the valve body 408. When the air bleeder assembly 128 is placed in the open configuration 436, by sliding the plunger 420 to the second position, the trapped air in the non-spring cavity 306 can bleed to the atmosphere via the flow path 415.

A seal receiving groove 1006 can be located in the valve body 408, toward the second end 412 and away from the first end 410. A dust seal 433 can be placed in the dust seal groove 1006 to surround and encircle the valve body 408. When the air bleeder assembly 128 is placed in the closed configuration 450 (FIG. 4B), the inner surface 452 of the pull knob 206 can contact the second end 412 of the valve body 408 and the dust cover 430 of the pull knob 206 extends over and encircle the dust seal 433. The dust seal 433 provides a sealing engagement between an interior surface of the dust cover 430 and the valve body 408. This dust seal 433 is configured to prevent the ingress of debris into the air bleeder assembly 128 when the air bleeder assembly 128 is in the closed configuration 450.

Preferably, the air bleeder assembly 128 includes a compression spring 434 that biases the plunger 420 to the first (closed) position, in which the air bleeder assembly is in the closed configuration 450. The spring 434 is depicted as extending between a spring engaging ledge 908 on the plunger 420 and a spring engaging ledge 1002 internal to the valve body 408. The spring 434 can maintain the air bleeder assembly 128 in the closed configuration 450, absent the application of a force sufficient to overpower the spring 434.

When a user decides to bleed air from the non-spring cavity 306, the user will reach for the pull knob 206. The user can place one finger in each of the finger receiving grooves 204 and can grasp the grasping rim 429 of the pull knob 206. The user will pull the pull knob 206 outwardly away from the housing 402, overpowering the spring 434.

As the user pulls the pull knob 206, the proximal end 422 of the plunger 420 slides toward the expanded diameter 418. The spring 434 is compressed when the plunger 420 is moved outwardly toward the second position. In particular, the spring 434 is compressed between the spring engaging ledge 908 on the plunger 420 and a spring engaging ledge 1002 internal to the valve body 408.

The user will continue to pull outwardly on the pull knob 206 until the proximal end 422 of the plunger 420 reaches the expanded diameter 418 and the plunger 420 is placed in the second open position. When the user moves the plunger 420 to the second position, the plunger 420 and main bleed seal 428 fail to completely block the passageway 414 placing the air bleeder assembly 128 in the open configuration 436, so that air can bleed from the non-spring cavity 306 through the flow path 415 to the atmosphere.

When the plunger 420 is in the second position and is released by the user, the now compressed spring 434 expands linearly outwards to force the plunger to move linearly in a proximal direction back into the first position returning the air bleeder assembly 128 to the closed configuration 450. In this manner, the air bleeder assembly 128 can be operated without any tools. Moreover, the pull-out-to-bleed design of the air bleeder assembly 128 greatly reduces the likelihood that a user's finger will block the bleed passageway, as occurred with push to bleed designs of the prior art.

In one exemplary form, the air bleeder assembly 128 can be configured to include an automatic bleed function, which is configured to bleed air from the non-spring cavity 306 absent user intervention. As has been discussed, increased pressure within the non-spring cavity 306 relative atmosphere pressure can result in undesirable suspension characteristics. Increased air pressure within the non-spring cavity 306, relative to atmospheric pressure, will result in a force (“air pressure force”) being applied at the proximal end 422 of the plunger 420. A compression spring 434 is configured to exert an expansionary force (“spring force”) on the plunger 420 which acts against the air pressure force. This spring 434 can bias the air bleeder assembly 128 to the closed configuration.

The automatic bleed function is enabled through selection of a spring 434 which is configured to exert a spring force on the plunger 420 which is less than or equal to the air pressure force exerted on the plunger 420 when bleeding may be desired. For example, the bleed threshold pressure can be determined, which is the pressure at which a user will likely desire to bleed the non-spring cavity 306. Once the bleed threshold pressure is determined, the air pressure force on the plunger 420 can be determined. A compression spring 434 can then be selected which will exert a spring force that is less than or equal to the air pressure force at the bleed threshold pressure.

In this manner, if the air pressure within the non-spring cavity 306 increases to the bleed threshold pressure, the air pressure force will overpower the spring force to compress the spring and the plunger 420 will be moved linearly in a distal direction to the second position, placing the air bleeder assembly 128 in the open configuration 436. The bleeder assembly 128 will remain in this open configuration 436 until the pressure within the non-spring cavity 306 is reduced to a level such that the spring force exerted by the spring 434 on the plunger 420 exceeds the air pressure force exerted on the proximal end 422 by the air pressure force. When the spring force exceeds the air pressure force, the plunger 420 will be moved linearly in a proximal direction to return the plunger 420 to the first position and the air bleeder assembly will be placed in the closed configuration 450.

The fork assembly 100 has been described herein as including spring leg 124 having air bleeder assembly 128 attached thereto and damper leg 126 with air bleeder assembly 130 attached to the damper leg 126. However, depending upon the specific design parameters and fork construction, an air bleeder may be located solely at one leg with the other leg failing to include an air bleeder.

Alternately, both legs may include a singular air bleeder, or one or more legs may include multiple air bleeders. Springs 434 of varying force may be provided with the air bleeder assembly 128 to enable the user to set the automatic bleed to occur in response to various internal pressures.

Threads 1004 enable the air bleeder assembly 128 to be removed easily from the fork assembly 100 to enable a user to change the springs 434. This removably impacts adjustability to the device, along with easy repairability. Additionally, the air bleeder assembly 128 can be can be provided as a stand-alone component which can be retrofit to various forks or can be provided with a fork assembly 100.

Exemplary materials will now be discussed. The chassis crown 106, linearly fixed tubes 110, stanchions 116, axle 122, pull knob 206, valve body 408, crown ring 404, and steering tube 108 can be manufactured from aluminum. The plunger 420 can be formed of brass and the sealing members (e.g., 433, 435, 428) can have a polymeric construction.

The chassis crown 106 can be constructed from 6061-T6511 aluminum, the fixed tubes 110, can be constructed from 7075-T6 aluminum. The stanchions 116 can be formed of 7075-T6 aluminum. The crown ring 404, can be formed of 6061-T6 aluminum.

The valve body 408, can be constructed of 6061-T6 aluminum. The pull knob 206 can be constructed of 6061-T6 aluminum and the plunger 420 can be formed from alloy 360 brass. The sealing members can be formed of Buna-N, a synthetic copolymer made of acrylonitrile and butadiene that is quite commonly used in O-rings.

Specific, non-limiting exemplary materials and dimensions have been discussed herein with regard to the bleeder valve assemblies 128, 130 as well as the overall fork assembly 100. However, it is contemplated that the assemblies and components described herein can include a variety of dimensions and material constructions.

For example, many components discussed herein include an aluminum construction as such construction has been determined to provide an acceptable strength to weight ratio at a reasonable cost; however, various other materials can be utilized such as composites (e.g., carbon fiber, Kevlar, etc.), titanium, magnesium, steel and alloys thereof, and the like.

The dimensions discussed herein and shown in the fully incorporated provisional can be modified depending upon a specific application and design parameters. Although the fork assembly 100 has been described herein as a bicycle fork assembly 100, it is contemplated that the unique fork assembly 100 and air bleeder assemblies 128, 130 can be utilized for other vehicles having a fork-type chassis/suspension. For example, it is contemplated that the fork assembly 100 can be utilized for bicycles, motorcycles, various three wheeled trike type vehicles, and the like.

While the invention has been described in connection with what is presently considered to be the most practical and preferred embodiment, it is to be understood that the invention is not to be limited to the disclosed embodiment(s). On the contrary, the invention is intended to cover various modifications and equivalent arrangements included within the spirit and scope of the appended claims, which scope is to be accorded the broadest interpretation so as to encompass all such modifications and equivalent structures as permitted under the law.

It should be understood that while the use of the word preferable, preferably, or preferred in the description above indicates that feature so described may be more desirable, it nonetheless may not be necessary and any embodiment lacking the same may be contemplated as within the scope of the invention, that scope being defined by the claims that follow. The term “fluid” should be read in its broadest sense to encompass any flowable material, be it gaseous or liquid.

In reading the claims it is intended that when words such as “a,” “an,” “at least one” a “plurality” and “at least a portion” are used, there is no intention to limit the claim to only one item or one specific quantity of items unless specifically stated to the contrary in the claim. Unless specifically stated to the contrary in the claim, the language “at least one of X, Y, and Z” should be interpreted as including both the conjunctive and disjunctive forms.

Specifically, the language “at least one of X, Y, and Z” is intended to encompass the following permutations of X, Y, and Z: X alone; Y alone; Z alone; X and Y; X and Z; Y and Z; and X, Y, and Z. Further, when the language “at least a portion” and/or “a portion” is used the item may include a portion and/or the entire item unless specifically stated to the contrary.

What is claimed is:

1. An air bleed system, comprising:
a fork including a linearly fixed component, wherein the linearly fixed component includes a linearly fixed tube;
a linearly moving component including a linearly moving tube, wherein the linearly moving tube extends downwardly from the linearly fixed tube, wherein a proximal end of the linearly moving tube slidingly engages with the linearly fixed tube, wherein the linearly moving tube is configured to linearly move relative the linearly fixed component, and wherein a distal end of the linearly moving tube is configured to retain a wheel;
an internal cavity defined internal to the linearly fixed tube and/or the linearly moving tube; and
an air bleed assembly located at the linearly fixed component, wherein the air bleed assembly is configured to selectively place the internal cavity in fluid communication with an external atmosphere in response to the air bleed assembly being in an open configuration.

2. The air bleed system of claim 1, further comprising a spring cavity fill port, in fluid communication with an air spring cavity.

3. The air bleed system of claim 1, wherein a portion of the air bleed assembly extends through an outer wall of the linearly fixed tube, and wherein the air bleed assembly is in fluid communication with a trapped air non-spring cavity.

4. The air bleed system of claim 3, wherein the air bleed assembly extends through a chassis crown.

5. The air bleed system of claim 1, wherein the air bleed assembly further includes a control knob, wherein at least a portion of the control knob extends outwardly from linearly fixed tube, and wherein moving the control knob to an outward orientation, away from the internal cavity, transitions the air bleed assembly to the open configuration.

6. The air bleed system of claim 5, wherein the air bleed assembly includes:
a valve body extending between a first end and a second end, wherein the valve body defines a fluid passageway extending between the first end and the second end;
a plunger having a proximal end and a distal end, the plunger being slidingly disposed within the fluid passageway, wherein the control knob is operably coupled with the distal end of the plunger; and
wherein the proximal end of the plunger is configured to obstruct the fluid passageway when the air bleed assembly is in a closed configuration, wherein fluid communication between the internal cavity and the atmosphere is prevented when the air bleed assembly is in the closed configuration.

7. The air bleed system of claim 6 wherein the plunger has a circumference further comprising a seal extending around the circumference of the plunger at a location near the proximal end of the plunger, and wherein the seal is configured to sealingly engage between the plunger and valve body when the air bleed assembly is in the closed configuration.

8. The air bleed system of claim 7, wherein the proximal end of the linearly moving tube is slidably interiorly received by a distal end of the linearly fixed tube, and wherein a sliding seal is located between an inner wall of the linearly fixed tube and an outer wall of the linearly moving tube.

9. The air bleed system of claim 1, wherein the internal cavity comprises a trapped air cavity located in a damper leg, wherein the air bleed assembly is located at the chassis crown of the damper leg, further comprising a second air bleed assembly located at the chassis crown of a spring leg, and wherein the second air bleed assembly is configured to selectively permit air to bleed from a trapped air cavity of the spring leg.

10. The air bleed system of claim 9, wherein the fork comprises a bicycle fork, further comprising an air adjustment knob located above a non-spring cavity of the spring leg, and further comprising a damper adjustment knob located above the damper leg.

11. A bicycle air bleed assembly, comprising:
a bicycle fork assembly including an internal cavity;
a valve body extending between a first end and a second end;
a fluid passageway extending internal to the valve body, wherein the passageway is in fluid communication with the internal cavity toward the first end of the valve body, and wherein the passageway is in fluid communication with an external atmosphere toward the second end of the valve body; and
a plunger having a proximal end and a distal end, wherein the proximal end of the plunger is slidably disposed in the fluid passageway internal to the valve body, wherein the plunger is configured to slide between a first closed position and a second bleed position, wherein when the plunger is located in the first position fluid flow through the passageway is obstructed, and wherein when the plunger is located in the second position fluid flow is permitted through the passageway between the internal cavity and the external atmosphere.

12. The bicycle air bleed system of claim 11, wherein in the first position the proximal end of the plunger is slid inwardly toward the first end of the valve body, and wherein in the second position the proximal end of the plunger is slid toward the second end of the valve body.

13. The bicycle air bleed system of claim 12, wherein the upper portion of the fork includes a chassis crown, and wherein valve body extends through the chassis crown.

14. The bicycle air bleed system of claim 12, further comprising a spring configured to act upon the plunger and bias the plunger to the first position.

15. The bicycle air bleed system of claim 14, further comprising an automatic bleed.

16. The bicycle air bleed system of claim 15, wherein the plunger moves from the first position to the second position without user intervention when a force exerted on the proximal end of the plunger by the pressure within the internal cavity exceeds a force exerted on the plunger by the spring.

17. The bicycle air bleed system of claim 11, further comprising a main bleed seal that extends around the plunger, and wherein when in the first position the plunger and main bleed seal cooperate to obstruct the passageway.

18. The bicycle air bleed system of claim 12, further comprising a dust seal that extends around the valve body toward the second end of the valve body, wherein when in the first position, a cooperating sealing engagement between the dust seal, the valve body, and a dust cover prevents fluid flow through the passageway.
